(19) United States
(12) Patent Application Publication
(10) Pub. No.: US 2004/0050121 A1
(43) Pub. Date: Mar. 18, 2004

(54) Lock system with a function controlling mechanism

(76) Inventors: Rolf Bucker, Coburg (DE); Uwe Sommer, Effelder (DE); Jorg Ubelein, Grub am Forst (DE); Andre Gortz, Dresden (DE)

Correspondence Address: CHRISTIE, PARKER & HALE, LLP, 350 WEST COLORADO BOULEVARD, SUITE 500, PASADENA, CA, 91105, US

(21) Appl. No.: 10/432,142

(22) PCT Filed: Nov. 16, 2001
(86) PCT No.: PCT/DE01/04380

(30) Foreign Application Priority Data
Nov. 17, 2000 (DE) 100 57 007.0

(51) Int. Cl. B60R 25/00

(52) U.S. Cl. 70/237; 70/91

(57) ABSTRACT

A lock system is provided with a function controlling mechanism for control of the lock states unlocked, locked and optionally theft secure and child safety. The lock system is characterized by very short times for controlling the desired locking states and good suitability to various requirements with regard to construction space and functionality. The lock system comprises locking pieces, for example a turning latch or lock handle, in a lock for the mechanical locking of the door, at least one operating device in the form of an external door opener and/or an internal door opener, an optional locking cylinder, and elements for transmitting the operating force from the operating device to the locking pieces. The pieces of the function controlling mechanism (FSM), involved in controlling the locking state are not involved in the force path between the operating device and the locking pieces of the lock.

The invention relates to a lock system with a function controlling mechanism for controlling the lock states “unlocked”, “locked” and where applicable “theft-secured” as well as “child lock”, which is characterised by very short times for controlling the desired locking states and good suitability to various requirements with regard to construction space and functionality.

In the case of motor vehicles having a so-called passive-entry function in which the locking of the lock is carried out not by a key but by an interrogation as to authorised status initiated by operating the external door opener followed by motorised unlocking of the lock it may happen that the door cannot be opened immediately because the lock could not be unlocked quick enough. It is indeed fundamentally possible to shorten the operating time of the lock by using more powerful and faster drives but this involves a greater expense of materials and thus higher costs.

From DE 196 27 246 A1 a motor vehicle door lock is known which can occupy different function positions. By means of a lift magnet an additional security is provided whereby the lift magnet at the same time serves for rapid release of the lock wherein the locking elements of the lock are moved from the “theft-proof” state to the “unlocked” state. The lift magnet is controlled by actuating the external door opener and in the shortest possible time produces a closed force chain for transferring the operating force whereby the elements moved by the lift magnet are part of the force chain.

This solution has the drawback that the lift magnet has to be made relatively powerful in order to be able to ensure a sufficiently fast movement of the masses which are to be moved. This involves structural sizes which go against the idea of a space-saving compact design.

The object of the invention is therefore to develop a lock system with a function controlling mechanism, more particularly with a passive entry function whose switch times when changing between two functioning positions are shortened to an extent which is not significant in the operation of the lock system and without having to increase the cost of the drive.

Advantageously the function controlling mechanism is to form a simple compact functionally reliable structural unit which where necessary can be combined with electric and electronic components and which can be readily integrated into different vehicle locking systems.

According to the invention this is achieved through the characterising features of claim 1. The dependent claims describe preferred variations of the invention.

According to this all the parts of the function controlling mechanism lie outside of the force flow between the operating element and the locking part so that the switch processes are in practice no longer influenced by the masses which have to be moved. Furthermore the switch paths are kept very small.

Preferably at least one switch element (e.g. a points element) is provided which can be controlled by a drive and which in dependence on its position controls the movement of a coupling element on the operating element side which transfers the operating force, such that this coupling element where necessary enters into active relationship with a coupling element on the locking part side and transfers the positioning movement to the locking mechanism with the interposition of further elements (e.g. Bowden cable and/or lever mechanism). As drive for the controllable switch element can be used in particular a lift magnet, a rotary magnet or a so-called flap armature which can switch to and fro between two end positions. Step motors or direct current motors with gears can also be used however.

In order to be able to guarantee the functional reliability of the switch processes the elements involved in this are designed so that indeterminate intermediate positions are ruled out. This is simply achieved through stops which are always reached by means of the associated drive and restrict the switch path of the switch element. The desired precision can however also be achieved by using bi-stable spring elements which always jump over into one of two stable end positions.

In the case where guide tracks depict the displacement path of the coupling element on the operating element side the one end position of the movable part (e.g. the points element) represents the establishment of the active connection for the purpose of transferring the operating force and the other end position of the movable part represents the interruption of the active connection so that an operating force starting from a door opener cannot be transferred to the locking parts of the lock.

When using a guide track having at least one fork for the coupling element on the operating element side the switch element which can be controlled between the two end positions functions as the points element whereby a first fork leads the coupling element on the operating element side to engage with the coupling element on the locking part side and a second fork prevents engagement of the coupling elements.

The guide tracks for the coupling elements on the operating element side can be formed in different ways, e.g. in the form of a slide path, a slot, a rail or the like in or on which the coupling element on the operating element side is guided with sliding action. The guide track can however also be formed as a transversely sliding or pivotal or limitedly rotatable rail or the like on which the coupling element on the operating element side is guided whereby the transfer of the operating force can take place in one of the end positions of the rail.

Similarly various different designs of the points switch elements are possible. Thus the points element can be mounted pivotal or rotatable relative to a base which supports or forms the guide track. When using a guide track which can be displaced in translation across its extension direction the coupling element on the operating element side is selectively moved to engage with the coupling element on the locking part side or so that engagement is prevented.

Another structural variation for controlling the path of the coupling element on the operating element side exists where the coupling element is mounted displaceable along a plane of adjustable incline whereby displacement of the coupling element on the operating element side along the inclined or straight plane prevents or produces its engagement on the coupling element on the locking part side. The conversion of the straight plane into an inclined plane can be carried out by swivelling a part mounted on a base or by sliding a preferably wedge-shaped part which after displacement releases the otherwise concealed inclined plane.

A further variation of the invention proposes that the coupling element on the operating element side is guided along a transversally displaceable guide track whereby the displacement across the extension direction of the guide track selectively permits or prevents engagement of the coupling element on the operating element side with the coupling element on the locking part side.

In order to couple the operating forces which emanate from the door openers it is also possible to provide a simple non-forked guide track for the operating element on the locking part side into which an operating lever connected to the coupling element on the lock side can be displaced so that the operating lever crosses the guide track and can enter into engagement with the coupling element. Moving the operating lever is likewise carried out by means of a drive which is activated through corresponding control commands or—in the case of emergency operation when the on-board electric supply fails—by actuating the locking cylinder.

In order to achieve the most compact construction possible for the function controlling mechanism the force-transferring means (e.g. operating cable or operating rod linkage) which are directly connected to the coupling elements on the operating element side are mounted on the one side of a base plate or the like supporting the guide tracks whilst the means for force transfer connected to the coupling element on the locking part side are mounted on the other side of this base. The coupling elements on the operating element side project sufficiently far beyond the base so that during their displacement along the guide track an engagement can be produced with a part (e.g. a pivotally mounted operating lever) connected to the coupling element on the locking part side. The device can be made more compactly and the cost of the component parts can also be considerably reduced through a symmetrical construction of a part of the mechanical structural elements or function regions on the external door opener side and the internal door opener side. Particularly suitable for a symmetric arrangement are the guide tracks for the coupling elements on the operating element side where their positioning is carried out so that the transfer of the operating force to the coupling element on the lock side can be undertaken by a common operating element.

Apart from the different possibilities of arranging the component parts and function regions in one plane these can also be positioned in superposed planes.

For manually controlling the different switch states of the lock the function controlling mechanism has a switch lever which is mounted pivotal in its middle region. Its ends have stops which are connected to followers of the control rod linkage which is connected to the drives. Between the pivotal axis of the switch lever and one of its ends a force transfer element (e.g. cable) engages which is connected to the locking cylinder of the vehicle door so that when the locking cylinder is actuated in the “OPENING” or “CLOSING” direction the switch elements can be brought into the corresponding switch positions for the purpose of emergency opening or emergency closing.

Preferably a pivotal operating lever is mounted on the same axis with its ends engaging with the coupling elements which are displaceable along the guide tracks when the lock is unlocked and an operating force is introduced through one of the door openers. The operating lever is thereby pivoted and transfers to a force transfer element on the lock side engaging at a distance from the pivotal axis a setting path which finally leads to opening of the lock.

A preferred variation of the invention combines the function controlling mechanism with an electronic lock control which inter alia ensures the so-called passive entry function wherein an interrogation of the access authorisation is carried out through remote means and then where applicable the lock is moved into the unlocked state. An antenna integrated into the lock control or its housing ensures a short signal transmission path. It is also advantageous to allocate directly to the electronic lock control sensors or micro switches which signal the actuation of a door handle.

The function controlling mechanism and the electronic lock control preferably form one structural unit. A synergy effect can be achieved in that the conductor plate of the electronic lock control at the same time also serves as a mechanical support for the structural elements or function regions of the function control mechanism.

By way of example, the drives can be fixed and simultaneously electrically contacted on such a base; this can obviously also apply to the sensors which monitor the existing lock states, plugs and switches. Furthermore the conductor plate can also undertake purely mechanical tasks e.g. through integration of the guide tracks for the coupling elements on the operating element side and the bearing sites, eg for the points elements and the pivotal axes.

A compact highly integrated mechanical-electronic function controlling device of this kind forms a functionally reliable unit which can be manufactured cost-effectively and which can be pre-checked as regards all its functions.

The invention will now be explained with reference to some embodiments and the accompanying drawings in which:

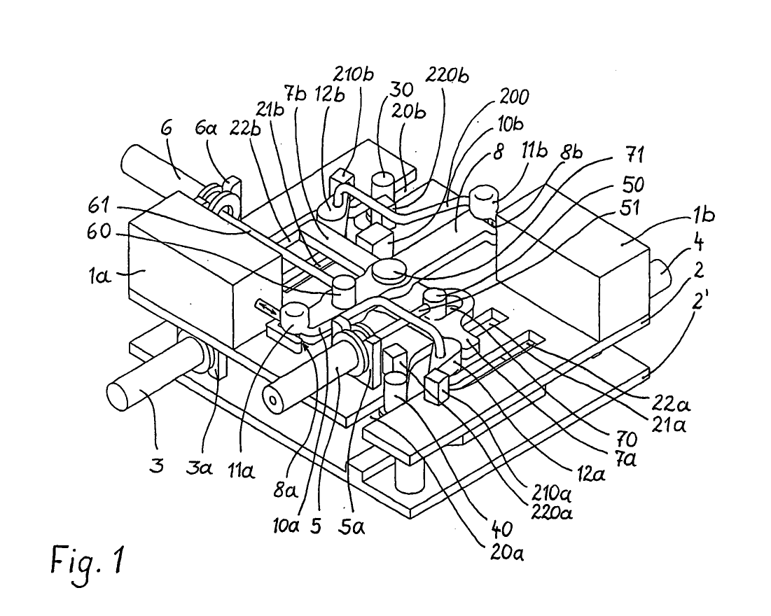

FIG. 1 perspective view of a function controlling mechanism having two base plates and switch elements which are located in the “UNLOCKED” position;

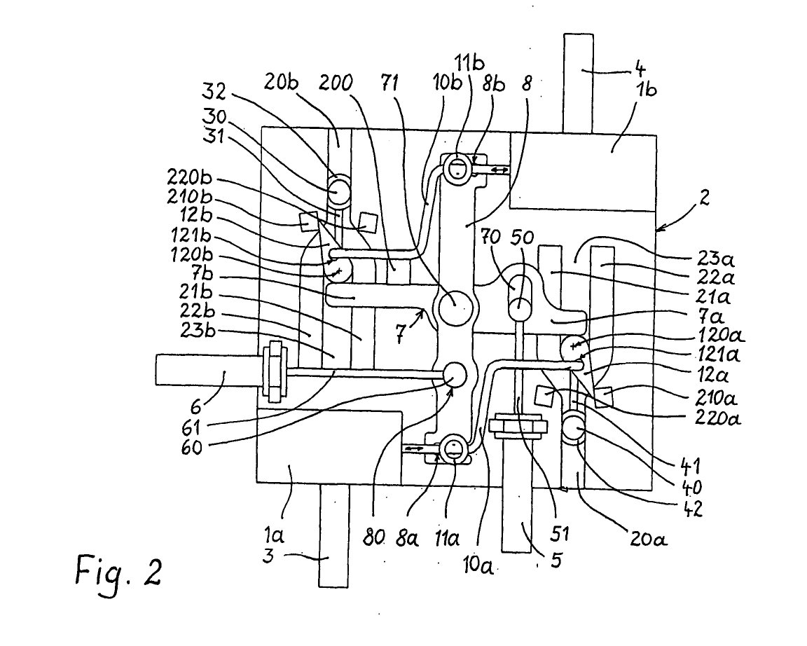

FIG. 2 plan view of the function controlling mechanism according to FIG. 1;

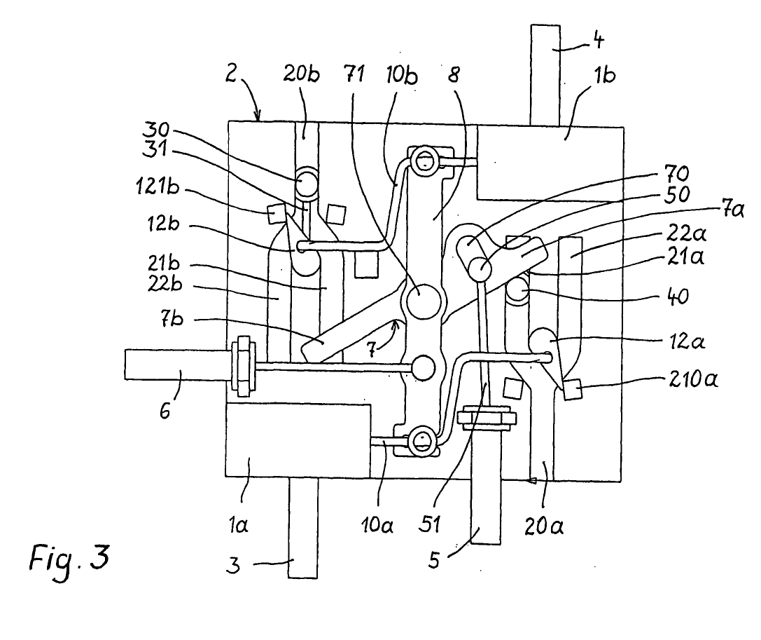

FIG. 3 plan view of the function controlling mechanism according to FIG. 1, but in the “ACTUATED” position controlled through the internal door opener;

FIG. 4 plan view of the function controlling mechanism according to FIG. 1, but in the “LOCKED” position;

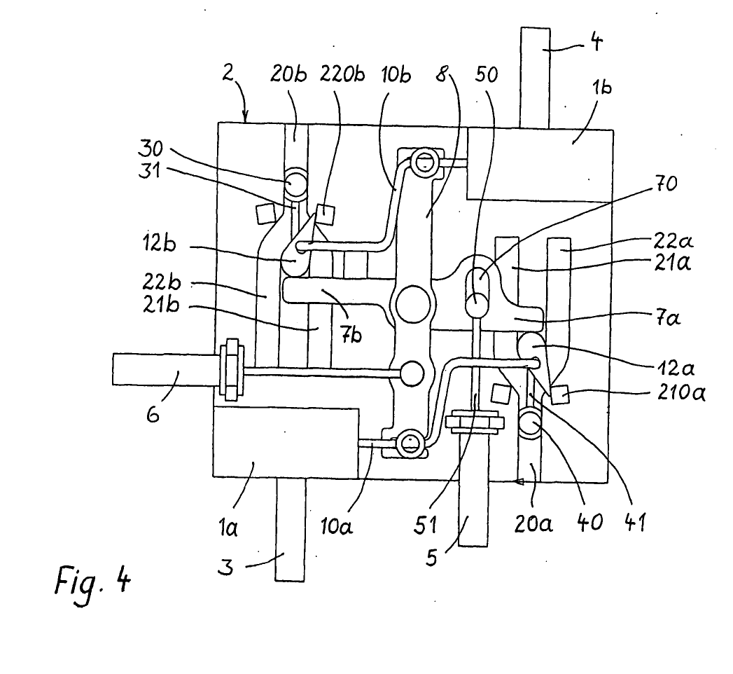

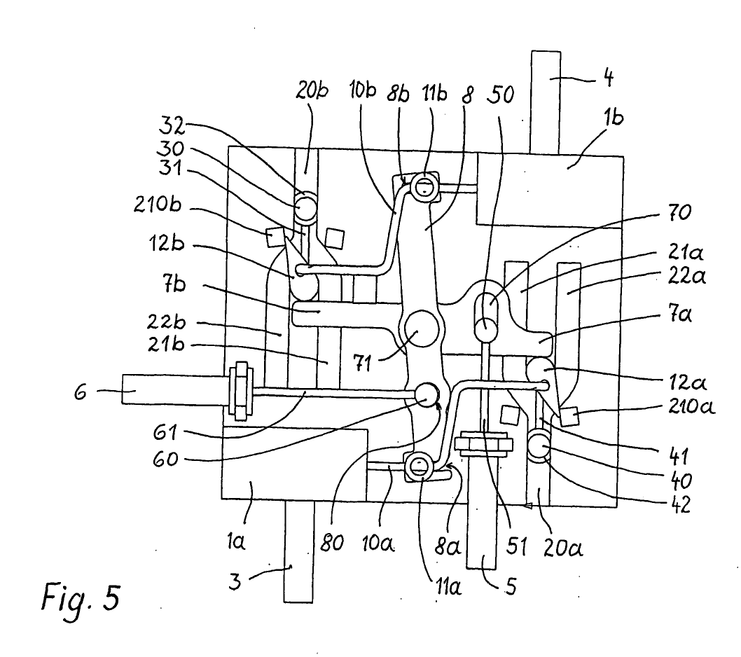

FIG. 5 plan view of the function controlling mechanism according to FIG. 1; but in the “EMERGENCY UNLOCKED” position controlled through the locking cylinder;

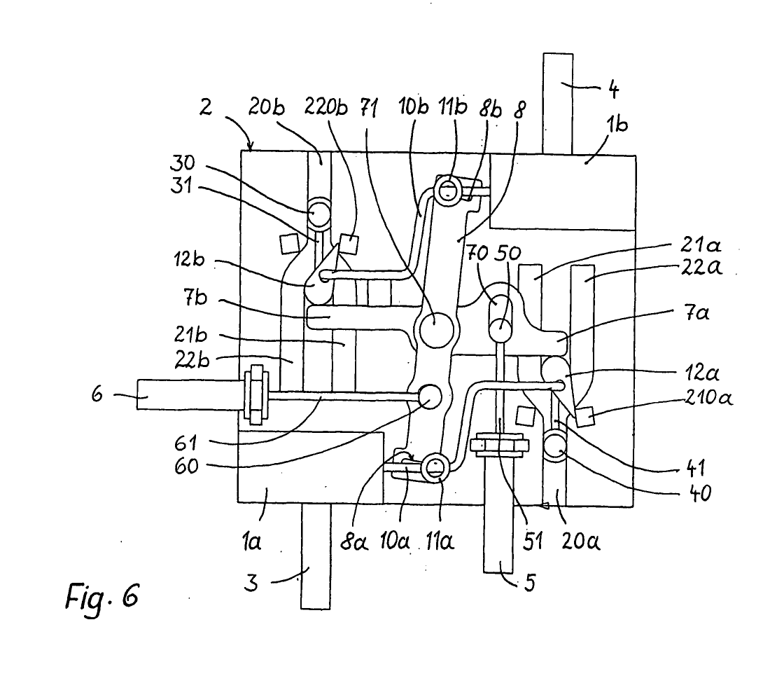

FIG. 6 plan view of the function controlling mechanism according to FIG. 1; but in the “EMERGENCY LOCKED” position controlled through the locking cylinder;

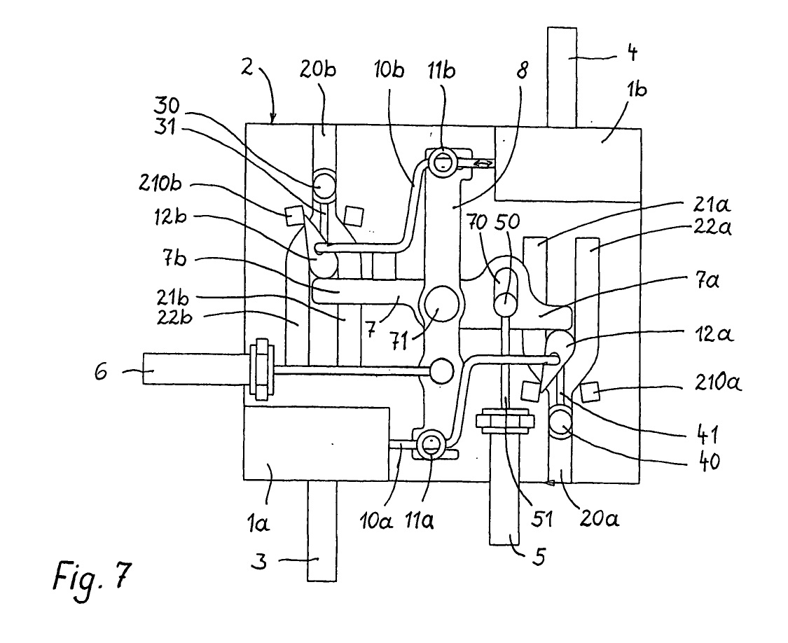

FIG. 7 plan view of the function controlling mechanism according to FIG. 1; but in the “CHILD LOCK” position;

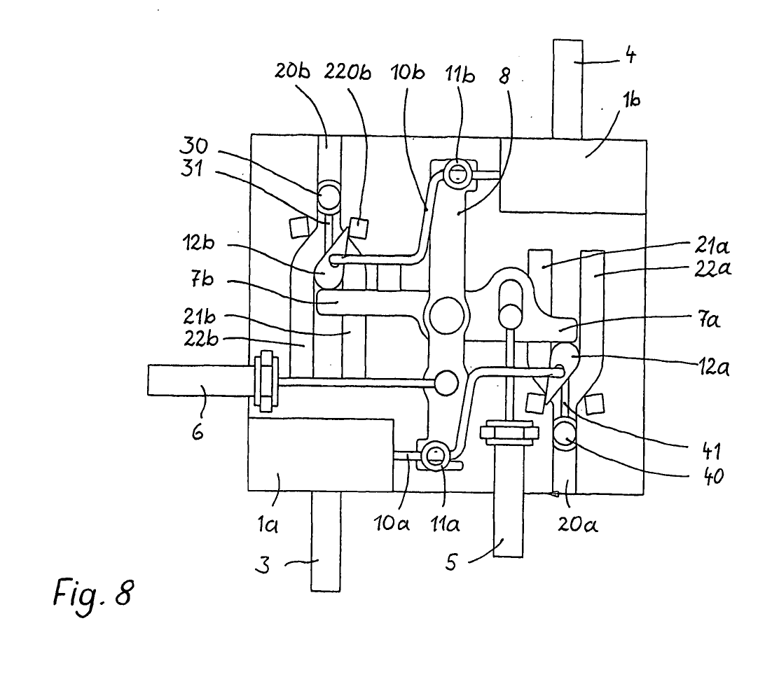

FIG. 8 shows a plan view of the function controlling mechanism according to FIG. 1; but in the “THEFT SECURED” position;

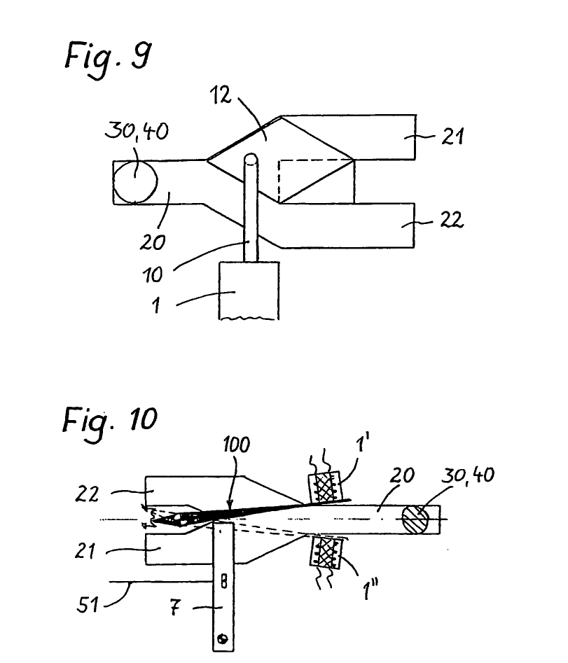

FIG. 9 diagrammatic view of a points switch for the guide tracks of the coupling elements on the operating element side with a switch element which is transversely displaceable;

FIG. 10 diagrammatic view of a points switch for the guide tracks of the coupling elements on the operating element side with an electromagnetic flap armature;

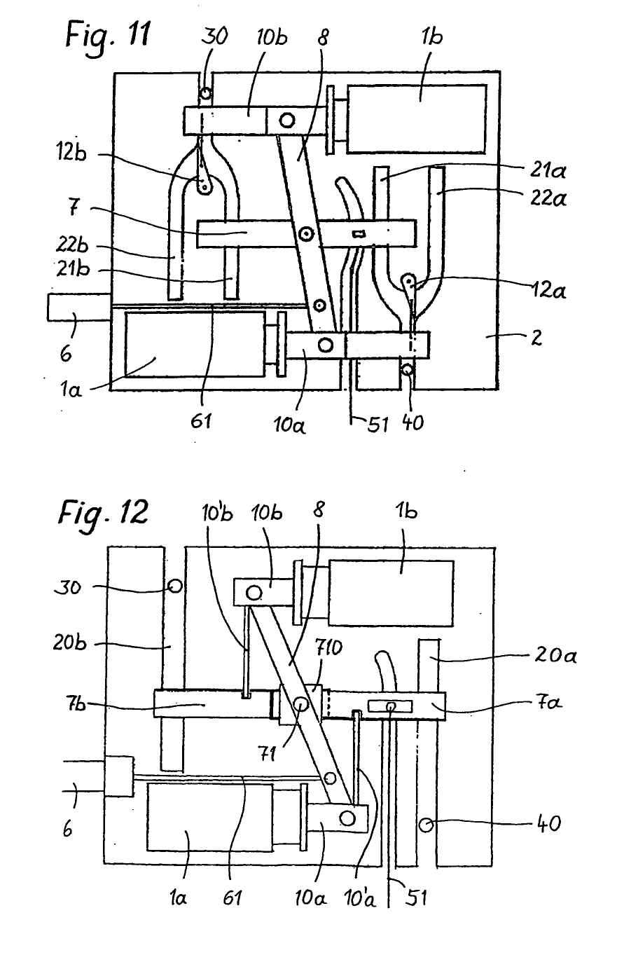

FIG. 11 diagrammatic view of the points switch principle with swivel mounted switch element for function control;

FIG. 12 diagrammatic view of an operating lever displaceable in the path of a simple guide track for function control;

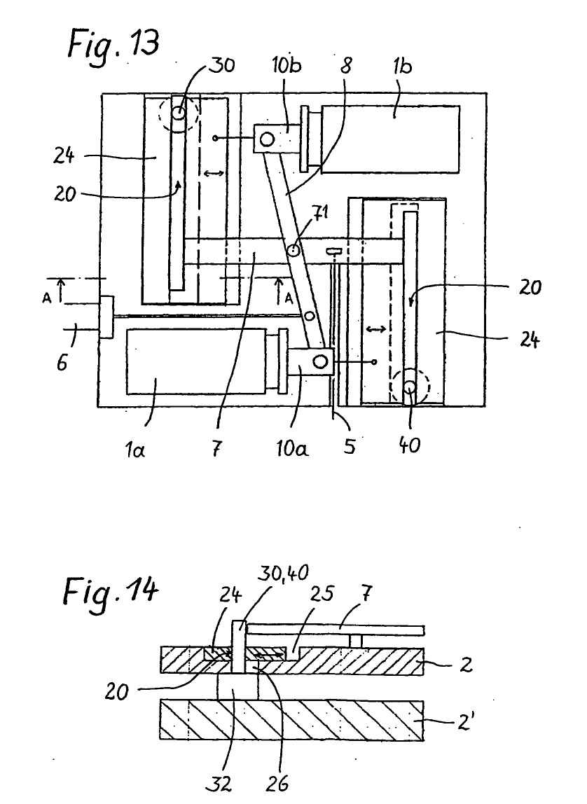

FIG. 13 diagrammatic view of simple guide tracks transversely displaceable in the engagement area of the operating lever for function control;

FIG. 14 cross-sectional view through a region of the device according to FIG. 13;

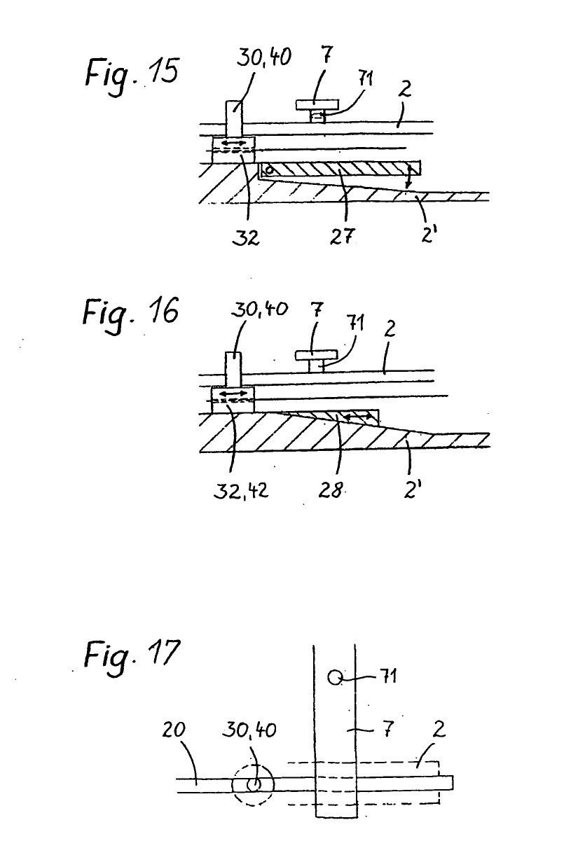

FIG. 15 cross-sectional view through a region of the function controlling mechanism having a pivotal guide plane for the coupling element on the operating element side for function control;

FIG. 16 cross-sectional view through a region of the function controlling mechanism with a displaceable wedge for the coupling element on the operating element side for function control;

FIG. 17 diagrammatic view of the plan view of the section of FIG. 15 and 16;

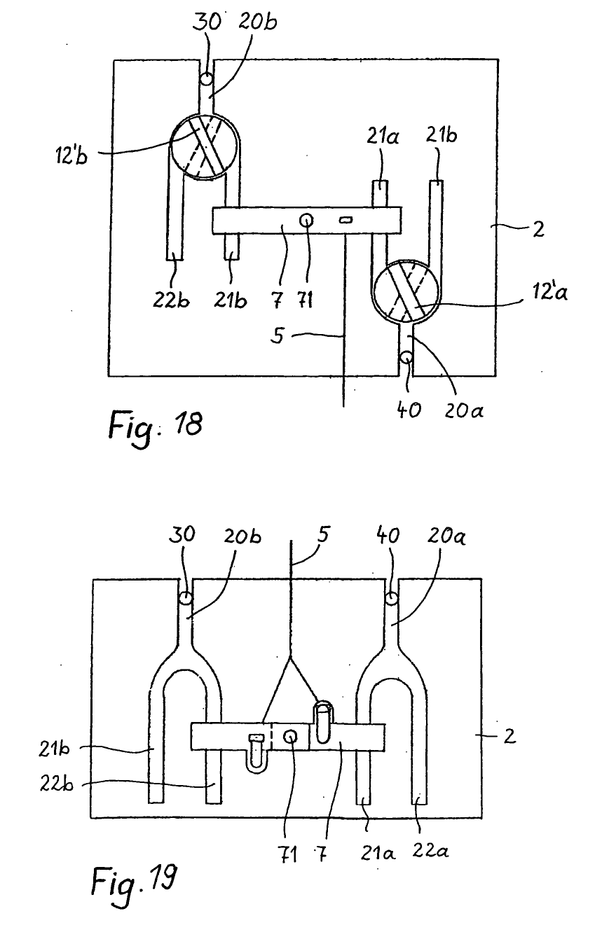

FIG. 18 diagrammatic view of the points switch principle by using a rotary armature or rotary magnet for function control;

FIG. 19 diagrammatic view of mirror-parallel arranged fork-like guide tracks;

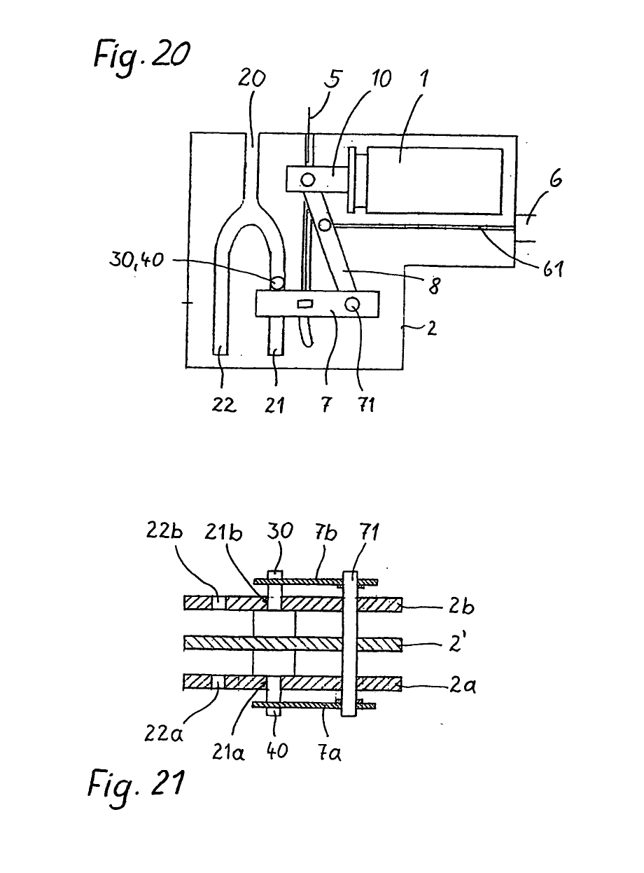

FIG. 20 diagrammatic view of the upper of several planes of a function controlling mechanism having a fork-like guide track;

FIG. 21 cross-section through the planes of the mechanism according to FIG. 20;

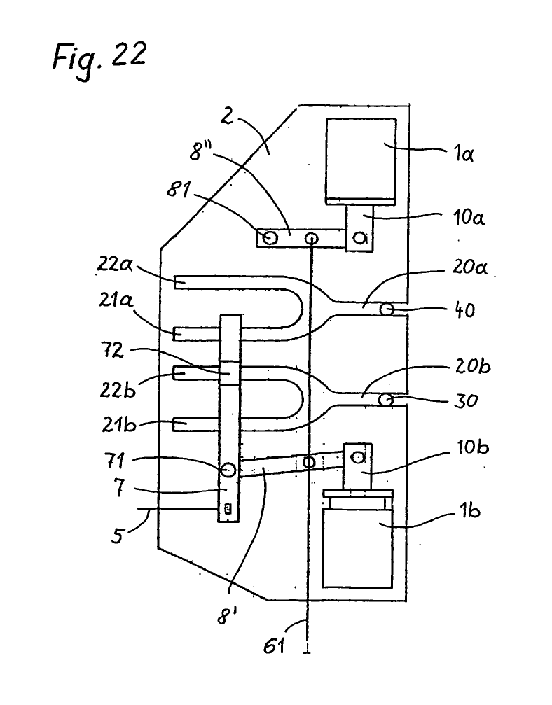

FIG. 22 diagrammatic view of mirror parallel fork-like guide tracks and a pair of switch levers;

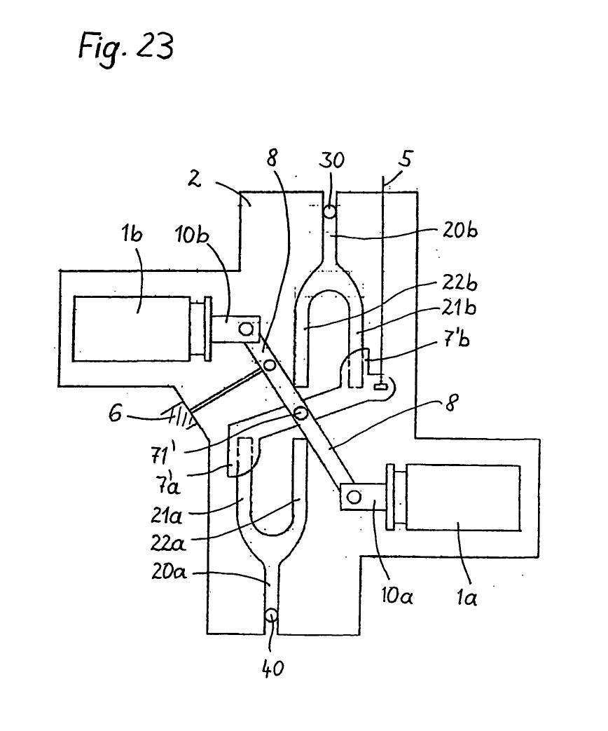

FIG. 23 diagrammatic view of an axially symmetrical function controlling mechanism;

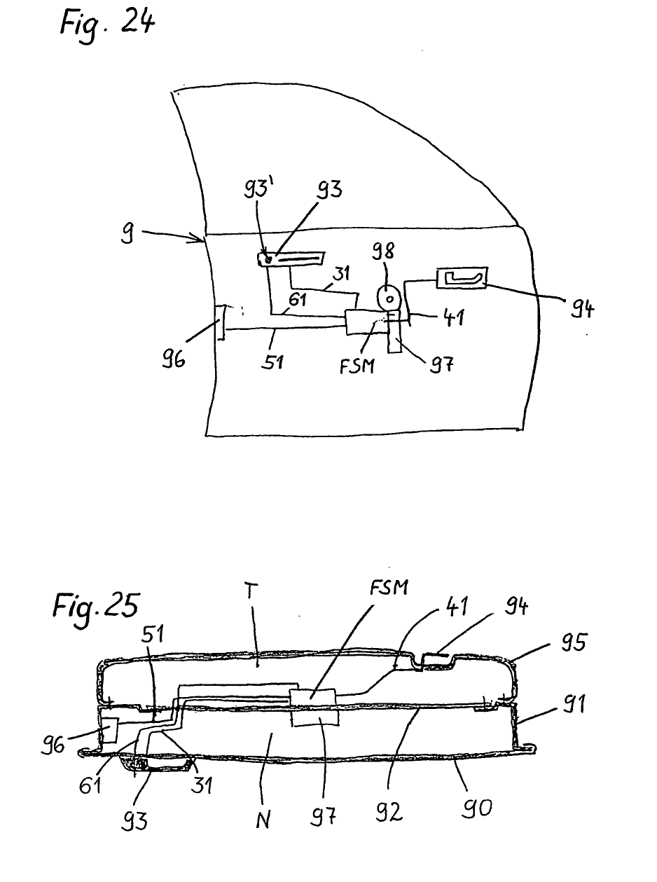

FIG. 24 diagrammatic side view of a motor vehicle door with function devices;

FIG. 25 diagrammatic view of a cross-section through a vehicle door.

The embodiment of a function controlling mechanism illustrated in different functioning positions in FIGS. 1 to 8 has a lower base plate 2′ and an upper base plate 2 spaced therefrom and on which drives 1a, 1b are arranged in the form of lift magnets in opposite corner regions. Each lift magnet 1a, 1b has an axially displaceable coupling rod 10a, 10b whose free ends engage in openings 121a, 121b of swivel mounted switch elements 12a, 12b. The switch elements 12a, 12b are supported by axes 120a, 120b on webs 23a, 23b which separate the parallel guide tracks 21a, 21b, 22a, 22b formed in the base plate 2, from each other. In the forked area these are combined in the neutral guide track 20a, 20b in which the coupling elements 30, 40 on the operating element side are mounted when no setting movement emanates from the door openers.

The Bowden tube ends 3, 4 on the operating element side are supported on fixing blocks 3a between the base plates 2, 2′; the Bowden tube ends 5, 6 which are connected to the lock or the locking cylinder are suspended in fixing blocks 5a, 6a above the base plate 2. Also the base bodies 32, 42 of the coupling elements 30, 40 connected to the cable pulleys 31, 41 are mounted between the two base plates 2, 2′ and ensure that the ends of the coupling elements 30, 40 projecting beyond the opposing side of the base plate 2 do not tilt on stopping against the operating lever 7.

In FIGS. 1 and 2 the switch elements 12a, 12b are located in the “UNLOCKED” position, i.e. an operating force introduced through the Bowden tube ends 3, 4 and the cable pulleys 31, 41 from the external door opener or internal door opener can be transferred to the cable pulley 5 which is connected to the locking parts of the lock. For this purpose an operating lever 7 is pivotally mounted on the base plate 2 in the axis 71 and its ends 7a, 7b cross the inner guide tracks 21a, 21b of the forked areas and thus are in the engagement region of the coupling elements 30, 40 when the switch elements 12a, 12b bear against the stops 210a, 210b and thus release the change-overs from the neutral guide tracks 20a, 20b into the guide tracks 21a, 21b.

If now one of the two door handles is actuated then the coupling element 30, 40 is moved towards the corresponding end 7a, 7b of the operating lever 7 and swivels same about its axis 71. FIG. 3 shows a device actuated from the internal door handle. This results in a positioning movement of the cable pulley 51 which is connected to the locking parts of the lock and which is engaged through a coupling element 50 which stops against the operating lever 7 at a distance from the rotary axis 71. The oblong hole 70 serves only as compensation for the cable pulley when the locking parts of the lock are not in the closing position but in the so-called pre-catch position or when the door is opened.

In FIG. 4—in comparison with FIG. 3—the switch element 12b was swivelled by the drive 1b through the coupling rod 10b towards the inner stop 220b whereby the outer guide track 22b for the coupling element 30 connected to the external door handle is disconnected and the inner guide track 21b is blocked. On actuating the external door handle it thus does not lead to engagement of the coupling element 30 with the operating lever 7 whilst the lock can be further actuated through the internal door handle. This switching state is termed “LOCKED”.

In order to be able to ensure emergency operation of the lock in the event of failure of the on-board electric supply a switching lever 8 is provided which is likewise pivotally mounted on the axis 71 and engages with a coupling element 60 which is in active connection through a cable pulley 61 or a rod linkage with a locking cylinder. FIG. 5 shows the “EMERGENCY UNLOCKED” position in which the switch elements 12a, 12b are located in the position already shown in FIG. 2 so that the door lock can be opened by both door handles. In the event of emergency unlocking by rotating the locking cylinder the coupling element 60 is pressed through the sufficiently pressure-resistant cable pulley 61 against the switch lever 8 and is pivoted. Stops at the ends 8a, 8b of the switch lever 8 thereby enter into engagement with followers 11a, 11b which are fixed on the coupling rod 10a, 10b. For the case where the function controlling mechanism is located in the “LOCKED” or “THEFT PROOF LOCKED” state it comes through the corresponding operation of the locking cylinder to a switch effect which pivots the switch elements 12a, 12b against the stops 210a, 210b.

The illustration of FIG. 6 shows the function controlling mechanism in the “EMERGENCY LOCKED” state. This is reached by an oppositely directed operating movement of the locking cylinder whereby a positioning path is transferred through the cable pulley 61 to the switching lever 8 to press the side stop of the slide guide 8b against the follower 11b on the external door handle side and through displacement of the coupling rod 10b pivots the switch element 12b against the inner stop 220b. Thus the access of the coupling element 30 connected to the external door handle to the associated end 7b of the operating lever 7 is ruled out. For safety reasons this does not apply for the coupling element 40 on the internal door opener side so that an accidentally shut in person can free himself. Therefore the slide guide 8b is open on one side and therefore only forms a side stop for the follower 11a for emergency unlocking.

FIG. 7 shows the “CHILD LOCK” position in which the coupling element 40 on the internal door opener side is deflected by points-like switch elements 12a into the outer guide track 22a whilst the coupling element 30 on the external door opener side is provided with access to the operating lever 7 along the inner guide track 21b.

In the “THEFT PROOF LOCKED” position (FIG. 8) the inner guide tracks 21a, 21b are blocked by the switch elements 12a, 12b so that actuation of the lock is not possible either through the external door opener nor through the internal door opener. Changing over the switch elements 12a, 12b into the “UNLOCKED” state can—as already explained in connection with the previously described figures—take place by controlling the drives 1a, 1b or by operating the locking cylinder.

At this stage it should be pointed out that the base plate 2 can also be formed as a conductor plate of an electronic control unit. In particular electronic elements mounted between the base plates 2, 2′ are particularly well protected from mechanical damage. Where necessary obviously the second base plate 2′ can also function as a conductor plate. Monitoring the locked state can advantageously be carried out by sensors which sense the actual pivotal position of the switch elements 12a, 12b. For this magneto-resistive elements are particularly suitable because they are comparatively insensitive to external influences.

The diagrammatic illustration of FIG. 9 shows a neutral guide track 20 which is forked into two parallel guide tracks 21, 22 and a rhomboid shaped switch element 12 which is displaceable across the guide tracks and which is controllable by a drive 1 through a coupling rod 10.

A further possibility for controlling the path of the coupling elements 30, 40 on the operating element side along the forking guide tracks 20, 21, 22 is shown diagrammatically in FIG. 10. Here a pivotally mounted flap armature 100 is selectively controlled by coils 1′, 1′ which are arranged in the forked area on opposite sides of the neutral guide track 20 and move the flap armature 100 by generating suitable magnetic forces and hold it in the desired position. In the illustrated armature position the engagement of the coupling element 30, 40 on the operating lever 7 is guaranteed whose swivel movement on the coupling rod 51 is transferred into a push movement and is directed up to the door lock.

FIG. 11 shows (analogous with the principle according to FIGS. 2 to 8 ) once again a diagrammatic illustration of the construction of a function controlling mechanism with forking guide tracks 21a, 21b, 22a, 22b and swivel switch elements 12a, 12b which are movable through coupling rods 10a, 10b between two end positions.

The variation according to FIG. 12 has for each coupling element 30, 40 on the operating element side only one simple (not-forked) guide track 20a, 20b. By using an operating lever which is basically divided into two parts 7a′ and 7b′ which are mounted displaceable independently of each other in a cassette 710 the free ends of the parts 7a′, 7b′ can selectively be brought into the guide track 20a, 20b and thus into the engagement area of the coupling elements 30, 40. For this the operating lever halves 7a′, 7b′ are coupled to the drives 1a, 1b through a coupling rod linkage 10a, 10a′, 10b, 10b′. Where necessary an emergency actuation for the purpose of emergency opening or emergency closing can take place through the switch lever 8 which is mounted in the common pivotal axis 71 and which is connected to the locking cylinder through the connecting element 6 and the cable or rod linkage 61.

Also the function controlling mechanism shown in FIG. 13 uses only simple (non-forked) guide tracks 20. Compared with the embodiment of FIG. 12 the guide track 20 is here a constituent part of a transversely displaceable part 24 which is mounted in a channel-like recess 25 of the base plate 2. The coupling element 30, 40 thereby engages through a slit 26 which is formed in the base plate 2 underneath the guide track 20 and whose width is designed so that there is sufficient clearance for the proposed transverse displacement of the coupling elements 30, 40 (see also FIG. 14). According to FIGS. 13 and 14 the operating lever 7 does not cross the transversely displaceable guide track 20 so that with the introduction of an operating force none of the coupling elements 30, 40 can act on the associated free end of the operating lever 7. This system is thus located in the “THEFT PROOF LOCKED” state.

A further possibility which selectively enables or prevents the engagement of a coupling element 30, 40 on the operating lever 7 exists in selectively varying the projection height of the coupling elements 30, 40 from the region between the base plates 2, 2′ towards the operating lever 7. I.e. that the projection height is maximised when the operating force is to be transferred through the coupling element 7 to the locking parts of the lock (see FIGS. 15 and 16). If on the other hand a transfer of the operating force through at least one of the coupling elements 30, 40 is to be prevented because for example the system is locked, theft proof locked or child locked, then the coupling element 30, 40 is guided along an inclined plane which reduces the projection depth to an extent which is less than required for engagement with the operating lever 7.

In order to produce such inclined planes which represent the switching states of the function controlling device FIGS. 15 and 16 show two variations. On the one hand a part 27 is pivotally mounted on the base plate 2′ and its position determines the projection depth of the coupling element 30, 40. On the other hand a displaceable wedge 28 is provided whose wedge angle corresponds to that of the inclined plane underneath which is released during its displacement and then reduces the projection depth to a measure which lets the coupling element pass through under the operating lever. In the position of the web 28 shown in FIG. 16 this wedge forms with its outer contour an extension of the plane of the base plate 2′ running parallel to the guide track 20. FIG. 17 shows a diagrammatic plan view of the devices of FIGS. 15 and 16 shown in section.

FIG. 18 shows diagrammatically the control principle already illustrated and described with reference to FIGS. 1 to 8 by using a neutral guide track 20a, 20b which is forked into two guide tracks 21a, 21b, 22a, 22b whereby the displacement path is controlled through a points-like switch element. The displacement element 12a′, 12b′ proposed here is constructed on the principle of a rotary magnet or rotary armature which can be rotated to and fro between two end positions.

FIGS. 19 to 23 show some variations of possible symmetrical arrangements of the parts and function regions of the function controlling mechanism according to the invention. Thus FIG. 19 shows by way of example a mirror symmetrical arrangement of parallel and uni-directional guide tracks 20a, 20b, 21a, 21b, 22a, 22b. From FIGS. 20 and 21 a function controlling mechanism is shown having a symmetrical construction relative to the base plate 2′ with superposed base plates 2a, 2b supporting the guide tracks 20, 20a, 20b, 21, 21a, 21b, 22, 22a, 22b. These are associated with the drives 1, the coupling elements 30, 40 as well as the divided areas 7a, 7b of the operating lever which are mounted on a common axis 71.

FIG. 22 shows—similar to FIG. 19—mirror symmetrical and unidirectional mounted guide tracks 20a, 20b, 21a, 21b, 22a, 22b whose switch elements (not shown) are likewise associated with mirror symmetrical drives 1a, 1b which can be switched through parts 10a, 10b, 8′, 8″, 61. This embodiment has two switch levers 8′, 8′ whereby each individual part is mounted on one side on the coupling rod 10a, or 10b, of the drive 1a, 1b and on the other hand in a swivel axis 71, 81 which is fixed on the base plate 2. Between these connecting points operating means 61 engage on the switch lever 8′, 8″ in order when necessary to be able to initiate emergency operation through the locking cylinder. The operating lever 7 is pivotally mounted in the axis 71 and crosses the guide tracks 21a, 21b so that with a corresponding setting of the switch elements (not shown) an engagement can be produced with the coupling elements 30, 40. On the other hand the operating lever 7 is formed e.g. U-shaped in the intersection area so that the coupling element 30 can “tunnel under” the operating lever without stopping against same.

The function controlling mechanism according to FIG. 23 is constructed roughly symmetrical relative to the swivel axis 71′ whereby the swivel axis 71′ is not anchored on the base plate 2 but can move slightly as a result of the selected lever kinematics in the case of the switch processes emanating from the drives 1a, 1b or the locking cylinder (see connecting element 6). An illustration of the points-like switch elements and their coupling rods with the drives has been omitted.

FIG. 24 shows in a diagrammatic illustration the side view of a vehicle door with a function controlling mechanism FSM into which an electronic control for the lock 96 as well as window lifter is integrated. The window lifter motor 97 is therefore preferably in direct connection with the function controlling mechanism FSM which is also fed with current here. The operating forces and setting paths between the external door handle 93, the locking cylinder 93′, the internal door handle 94 and the door lock 96 on the one hand and the function controlling mechanism on the other are transferred through Bowden cables or rod linkages 31, 41, 51, 61.

FIG. 25 shows a cross section through the described vehicle door. According to this the door body is divided into a wet space N defined by the outside door panel 90 and inside door panel 91 and thus support plate 92 connected thereto, and a dry space T which extends between the support plate 92 and the inside door trim 95. As many function units as possible of the vehicle door are preferably preassembled on the support plate in order to achieve one comprehensively pre-checkable assembly system.

LIST OF REFERENCE NUMERALS

| | |
|---|---|
| 1, 1a, 1b | Drive for function controlling mechanism, e.g. lift magnet, |
| | rotary magnet or flap armature |
| 1′, 1″ | Electromagnet |
| 10, 10a, 10b | Coupling rod linkage |
| 10′a, 10′b | Coupling rod linkage |
| 11a, 11b | Follower |
| 12, 12a, 12b | Switch element, e.g. points element |
| 12′a, 12′b | Switch element with rotary magnet |
| 100 | Switch element in form of flap armature |
| 120a, 120b | Pivotal axis of switch element |
| 2, 2a, 2b | Base plate with guide tracks |
| 2′ | Base plate without guide tracks |
| 20, 20a, 20b | Neutral guide track |
| 21, 21a, 21b | First guide track of fork |
| 22, 22a, 22b | Second guide track of fork |
| 23a, 23b | Web in base plate |
| 24 | Transversely displaceable part with guide track |
| 25 | Channel like recess |
| 26 | Slit, underneath and parallel to guide track |
| 27 | Pivotal part (for producing an inclined plane) |
| 28 | Displaceable wedge (for releasing inclined plane) |
| 200 | Stop |
| 210a, 210b | Stop for switch element |
| 220a, 220b | Stop for switch element |
| 3 | Connector element, Bowden tube end (for transferring op- |
| | erating force of external door opener) |
| 3a | Fixing block |
| 30 | Coupling element |
| 31 | Cable pulley or rod linkage |
| 32 | Base body |
| 4 | Connector element, Bowden tube end (for transferring op- |
| | erating force of internal door opener) |
| 40 | Coupling element |
| 41 | Cable pulley or rod linkage |
| 42 | Base body |
| 5 | Connector element, Bowden tube end (for transferring op- |
| | erating force to locking parts of lock) |
| 5a | Fixing block |
| 50 | Coupling element |
| 51 | Cable pulley or rod linkage |
| 6 | Connector element, Bowden tube end (for transferring op- |
| | erating force of locking cylinder) |
| 6a | Fixing block |
| 60 | Coupling element |
| 61 | Cable pulley or rod linkage |
| 7 | Operating lever |
| 7a, 7b | Lever end |
| 7′a, 7′b | Lever end |
| 7a′, 7b′ | Displaceable part of operating lever |
| 70 | Oblong hole |
| 71, 71′ | Pivotal axis |
| 72 | Bridging area |
| 710 | Cassette |
| 8, 8′, 8″ | Switch lever |
| 8a, 8b | Lever end |
| 80 | Recess |
| 9 | Vehicle door |
| 90 | Outside door panel |
| 91 | Inside door panel |
| 92 | Support plate |
| 93 | External door opener |
| 93′ | Lock cylinder |
| 94 | Internal door opener |
| 95 | Internal trim |
| 96 | Lock |
| 97 | Motor of window lifter |
| 98 | Gearing |
| FSM | Function controlling mechanism |
| N | Wet space |
| T | Dry space |

1. Lock system with a function controlling mechanism for controlling the lock states of a motor vehicle door, such as unlocked, locked and where applicable theft-proof and child lock
with locking parts (e.g. latch and locking pawl) of a lock for mechanically locking the door,
with at least one operating device in the form of an external door opener and/or internal door opener,
where necessary with a locking cylinder and
with elements for transferring the operating force from an operating device to the locking parts characterised in that
all the parts (1, 1a, 1b, 1′, 1″, 10, 10a, 10b, 12a, 12b, 100) of the function controlling mechanism (FSM) involved in the control of the lock states are mounted outside of the force flow between the operating device (93, 94) and the locking parts of the lock (96).

2. Lock system according to claim 1, characterised in that at least one switch element (12, 12a, 12b) of the function controlling mechanism (FSM) controllable by a drive (1, 1a, 1b, 1′, 1″) is provided which controls in dependence on its position the movement of a coupling element (30, 40) on the operating element side transferring the operating force so that the coupling element where necessary enters into active connection with a coupling element (50) on the locking part side and transfers the setting movement emanating from the operating device (93, 94) to the lock mechanism through the interposition of further elements (e.g. Bowden cable 5, 51).

3. Lock system according to claim 2, characteris d in that the switch element (12, 12a, 12b, 100) can occupy solely discrete end positions.

4. Lock system according to claim 3 characterised in that the end positions of the switch element (12, 12a, 12b) are provided by stops (210a, 210b, 220a, 220b).

5. Lock system according to claim 1 characterised in that the drive is a lift magnet (1, 1a, 1b), a rotary magnet (12a′, 12b′) or a so-called flap armature device (1′, 1″, 100).

6. Lock system according to one of the preceding claims characterised in that the coupling element (30, 40) on the operating element side is in engagement with a neutral guide track (20, 20a, 20b) having at least one fork (21, 21a, 21b, 22, 22a, 22b) and that the switch element (12a, 12a′, 12b,12b′, 100) functions as a points switching element whereby a first guide track (21, 21a, 21b) guides the coupling element (30, 40) on the operating element side into active connection with the coupling element (50) on the locking part side and a second guide track (22, 22a, 22b) prevents the establishment of an active connection between the coupling elements (30, 40).

7. Lock system according to claim 6 characterised in that the guide tracks (20, 20a, 20b, 21, 21a, 21b, 22, 22a, 22b) are formed as a slide track, a slot or the like in which the coupling element (30, 40) on the operating element side is guided.

8. Lock system according to claim 6 characterised in that the guide track is formed as a rail or the like on which the coupling element on the operating element side is guided.

9. Lock system according to claim 6 characterised in that the switch element (12a, 12b, 100) functioning as the switching points element is mounted pivotal or rotatable relative to a base (2, 2a, 2b) supporting the guide tracks (20, 20a, 20b, 21, 21a, 21b, 22, 22a, 22b).

10. Lock system according to claim 6 characterised in that the switch element (12) functioning as the points switch element is mounted for displacement in translation relative to a base supporting the guide tracks (20, 21, 22).

11. Lock system according to one of the preceding claims characterised in that the coupling element (30, 40) on the operating element side is mounted displaceable along a plane which can be converted at least in part into an inclined plane whereby a displacement of the coupling element (30, 40) on the operating element side along the inclined plane prevents its engagement on the coupling element (50) on the locking part side or an element (7) connected thereto.

12. Lock system according to claim 11 characterised in that the conversion of the plane into an inclined plane is achieved by pivoting a part (27) mounted on a base (2′).

13. Lock system according to claim 11 characterised in that the conversion of the plane into an inclined plane is achieved by sliding a part (28) whereby the inclined plane underneath is released.

14. Lock system according to one of the preceding claims characterised in that the coupling element (30, 40) on the operating element side is mounted displaceable along a guide track (20) which is formed displaceable or pivotal transversely to its extension direction so that the engagement of the coupling element (30, 40) on the operating element side can be made or interrupted selectively with the coupling element (50) on the locking part side or an element (7) connected thereto.

15. Lock system according to one of the preceding claims charact rised in that for the purpose of coupling the operating force the operating element (50) on the locking part side or a part (operating lever 7) connected thereto can be displaced or pivoted in the guide track (20a, 20b) of the coupling element (30, 40) on the operating element side so that the operating lever (7) crosses the guide track (20a, 20b) and can enter into engagement with the coupling element (30, 40).

16. Lock system according to one of the preceding claims characterised in that the force-transferring means (Bowden cable 31, 41) directly connected to the coupling element (30, 40) on the operating element side is mounted on the one side of a base (2) supporting the guide tracks (20, 20a, 20b, 21, 21a, 21b, 22, 22a, 22b) and the coupling element (50) on the locking part side as well as the means (Bowden cable 51) directly connected thereto is mounted on the other side of this base (2) and that the coupling element (30, 40) on the operating element side engages through the base (2) from the one to the other side so far that during displacement along the guide track (21, 21a, 21b) an engagement can take place with a part (7) connected to the coupling element (50) on the locking part side.

17. Lock system according to one of the preceding claims characterised in that in order to achieve a space saving compact method of construction and to reduce the structural expense of the function controlling mechanism (FSM) at least one part of the mechanical structural elements or function regions (1, 1a, 1b, 2a, 2b, 10, 10a, 10b, 12, 12a, 12b, 20, 20a, 20b, 21, 21a, 21b, 22, 22a, 22b) on the external door opener side and internal door opener side have a symmetrical construction relative to each other.

18. Lock system according to claim 17 characterised by
a symmetry relative to a plane intersecting the base (2) so that the structural elements and function regions of the function controlling mechanism (FSM) are mounted on the base (2) adjacent one another and with parallel alignment or
a symmetry relative to an axis intersecting the base so that the structural elements and function regions of the function controlling mechanism (FSM) are mounted on the base (2) side by side with non-parallel and where necessary off-set alignment or
a symmetry relative to a plane parallel to the base (2, 2′) so that the structural elements and function regions of the function controlling mechanism (FSM) are mounted superposed on different bases (2a, 2b).

19. Lock system according to one of the preceding claims characterised in that a switch lever (8) which is pivotally mounted in its middle area is provided whose ends (8a, 8b) have stops which are connected to followers (11a, 11b) of the control rod linkage (10a, 10b) which is connected to the drives (1, 1a, 1b) and that between the swivel axis (71) of the switch lever (8) and one of the ends (8a, 8b) engages a force transfer element (61) which is connected to the locking cylinder of the vehicle door so that during actuation of the lock cylinder in the “OPENING” direction or “CLOSING” direction the switch elements (12, 12a, 1b) can be brought for the purpose of emergency opening or emergency closing into the corresponding switch positions.

20. Lock system according to one of the preceding claims characterised in that an operating lever (7) which is pivotally mounted in the middle region is provided whose ends (7a, 7b) with a corresponding switch position of the switch elements (12, 12a, 12b) and with the introduction of an operating force engage with coupling elements (30, 40) whereby the operating lever (7) swivels about its axis (71) and thereby transfers a setting path for the purpose of opening to the lock parts of the lock (96) through a force transfer element (51) which engages between the axis (71) and one end (7a).

21. Lock system according to claim 19 and 20 characterised in that the operating lever (7) and the switch lever (8) are mounted on a common axis (71).

22. Lock system according to one of the preceding claims charact rised in that the function controlling mechanism (FSM) has an electronic lock control.

23. Lock system according to claim 22, charact ris d in that the function controlling mechanism (FSM) and the electronic lock control form one structural unit.

24. Lock system according to claim 23 characterised in that the electronic lock control has a conductor plate or the like which serves at the same time as mechanical support (2, 2′, 2a, 2b) for structural elements or function areas (1, 1a, 1b, 2a, 2b, 10, 10a, 10b, 12, 12a, 12b, 20, 20a, 20b, 21, 21a, 21b, 22, 22a, 22b) of the function controlling mechanism (FSM).

25. Lock system according to claim 24 characterised in that in the conductor plate are integrated:
guide tracks (20, 20a, 20b, 21, 21a, 21b, 22, 22a, 22b) for the coupling elements (30, 40) on the operating element side and/or
bearing sites e.g. for the points elements (12, 12a, 12b) and the pivotal axes (71, 81) and/or
fixing sites e.g. for drives (1, 1a, 1b), plugs, switches and sensors for determining the lock state.

26. Lock system according to one of the preceding claims characterised in that the lock control is connected to an antenna for the so-called passive entry function whereby the antenna is preferably supported by the housing of the function controlling mechanism (FSM) or is integrated in its plastics wall.
